(19) United States
(12) Patent Application Publication
(10) Pub. No.: US 2013/0017712 A1
(43) Pub. Date: Jan. 17, 2013

(54) SIGNAL TRANSMISSION CABLE WITH INSULATION PIERCING TERMINALS

(71) Applicants: Da-Yu Liu, New Taipei City (TW); Da-Yung Liu, New Taipei City (TW); Teng-Lan Liu, New Taipei City (TW); Ben-Hwa Jang, New Taipei City (TW)

(72) Inventors: Da-Yu Liu, New Taipei City (TW); Da-Yung Liu, New Taipei City (TW); Teng-Lan Liu, New Taipei City (TW); Ben-Hwa Jang, New Taipei City (TW)

(21) Appl. No.: 13/183,563

(22) Filed: Jul. 15, 2011

(51) Int. Cl. H01R 4/24

(52) U.S. Cl. 439/391; 439/395

(57) ABSTRACT

A signal transmission cable with insulation piercing terminals includes a flat cable having a plurality of conductors, and a plurality of conductive terminals electrically connected to an end of the flat cable. The conductors respectively have a sheathed section, and a bare section located at an end of the sheathed section and having a length ranged between 0.01 mm and 4 mm. The sheathed sections are respectively surrounded by a first sheath before being together surrounded by a second sheath. The conductive terminals respectively include a spring contact and a plurality of piercing sections formed at an end of the spring contact for electrically connecting to the conductors of the flat cable. The bare sections with a defined length can reduce the stub effect on a signal transmitted via the signal transmission cable to achieve better impedance matching and reduced crosstalk interference during digital signal transmission.

### FIELD OF THE INVENTION

The present invention relates to a signal transmission cable, and more particularly to a signal transmission cable with insulation piercing terminals that includes a plurality of conductors respectively having a bare section formed at an end thereof, so as to reduce the stub effect on a digital signal being transmitted via the signal transmission cable and to achieve better impedance matching and reduced crosstalk interference during digital signal transmission.

### BACKGROUND OF THE INVENTION

The currently available electronic devices, depending on the hardware interfaces thereof, are often provided with different flat cables and adapters. For example, some of the currently very popular transmission interfaces include USB2.0, USB3.0, SATA, and HDMI. Based on these transmission interfaces, there is developed a technique of electrically connecting a flat cable with a connector using conductive terminals that pierce through the insulating sheaths of the flat cable.

FIGS. 1A and 1B are exploded and assembled perspective views, respectively, of a conventional flat cable 1. As shown, the flat cable 1 includes a plurality of signal transmission conductors 11, a full length of which is surrounded by an inner insulating layer 12 to prevent the signal transmission conductors 11 from electrically contacting with one another. The conductors 11 surrounded by the inner insulating layer 12 are further together surrounded by an outer insulating layer 13. The flat cable 1 is then connected at an end to a plurality of conductive terminals 20. Each of the conductive terminals 20 includes a spring contact 21 and a plurality of piercing sections 22 formed at an end of the spring contact 21. When the flat cable 1 is assembled to the conductive terminals 20, the piercing sections 22 respectively pierce through the outer insulating layer 13 and the inner insulating layers 12 to electrically connect to the signal transmission conductors 11, so that the flat cable 1 and the conductive terminals 20 are electrically connected to one another for transmitting signals. After the conductive terminals 20 have been connected to the flat cable 1, free ends of the piercing sections 22 are located outside the outer insulating layer 13 to form a plurality of stubs 221. The flat cable 1 can be used to transmit a digital signal, which can include a sine-wave signal containing from DC component to high-frequency component and is a broadband signal. A digital signal has a bandwidth in inverse proportion to a rise time of the digital signal. A low-speed signal has longer rise time and lower bandwidth, and will directly flow from the piercing sections 22 to the spring contacts 21 to achieve the purpose of signal transmission without being affected by the stubs 221. With the progress in the communication technological field, the digital signal can be now transmitted at a constantly increased speed and has largely shortened rise time and largely increased bandwidth. However, the stubs 221 will produce parasitic capacitance and inductance effect, which will affect the high-frequency component of the digital signal, so that there is a comparably large impedance variation between the signal transmission conductors 11 and the piercing sections 22 of the conductive terminals 20 to adversely influence the signal integrity and produce high crosstalk interference during digital signal transmission.

It is therefore tried by the inventor to develop a signal transmission cable with insulation piercing terminals that is able to overcome the problems in the conventional flat cable connected to insulation piercing terminals.

### SUMMARY OF THE INVENTION

A primary object of the present invention is to provide a signal transmission cable with insulation piercing terminals that includes a plurality of conductors respectively having a bare section formed at an end thereof, so as to regulate the stub effect of the signal transmission cable and to reduce impedance variation, maintain signal integrity and lower crosstalk interference during digital signal transmission.

To achieve the above and other objects, the signal transmission cable with insulation piercing terminals according to the present invention includes a flat cable having a plurality of conductors, and a plurality of conductive terminals electrically connected to an end of the flat cable. The conductors respectively have a sheathed section, and a bare section located at an end of the sheathed section and having a length ranged between 0.01 mm and 4 mm. The sheathed sections are respectively surrounded by a first sheath before being together surrounded by a second sheath. The conductive terminals respectively include a spring contact and a plurality of piercing sections formed at an end of the spring contact for electrically connecting to the conductors of the flat cable. The bare sections with a defined length can reduce the stub effect on a signal transmitted via the signal transmission cable to thereby achieve the effects of better impedance matching and lowered crosstalk interference during digital signal transmission.

In brief, the signal transmission cable of the present invention has the following advantages: (1) enabling lowered crosstalk interference during digital signal transmission; and (2) enabling enhanced signal integrity during digital signal transmission.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is an exploded perspective view of a conventional flat cable for connecting with insulation piercing terminals;

FIG. 1B is an assembled view of FIG. 1A;

FIG. 2 is an exploded perspective view of a signal transmission cable with insulation piercing terminals according to a first preferred embodiment of the present invention;

FIG. 3 is an assembled view of FIG. 2;

FIG. 4 is a sectional side view of FIG. 3;

FIG. 5A is a sectional side view of a signal transmission cable with insulation piercing terminals according to a second preferred embodiment of the present invention;

FIG. 5B is another sectional side view of the signal transmission cable according to the second preferred embodiment of the present invention;

FIG. 5C is a further sectional side view of the signal transmission cable according to the second preferred embodiment of the present invention;

FIG. 6A is an exploded perspective view of a signal transmission cable with insulation piercing terminals according to a third preferred embodiment of the present invention;

FIG. 6B is an assembled view of FIG. 6A;

FIG. 7A is an assembled perspective view of a signal transmission cable with insulation piercing terminals according to a fourth preferred embodiment of the present invention;

FIG. 7B is a fragmentary cross sectional view of the signal transmission cable of FIG. 7A;

FIG. 7C is an exploded perspective view showing the assembling of the signal transmission cable of FIG. 7A to a connector;

FIG. 7D is a cutaway view of the signal transmission cable of FIG. 7A assembled to the connector of FIG. 7C;

FIG. 8A is an assembled perspective view of a signal transmission cable with insulation piercing terminals according to a fifth preferred embodiment of the present invention;

FIG. 8B is an exploded perspective view showing the assembling of the signal transmission cable of FIG. 8A to a connector;

FIGS. 9A and 9B are charts indicating results from characteristic impedance tests conducted on the conventional flat cable with insulation piercing terminals as shown in FIG. 1B using a time domain reflectometer (TDR);

FIGS. 10A and 10B are charts indicating results from characteristic impedance tests conducted on another conventional flat cable with insulation piercing terminals using a TDR;

FIGS. 11A and 11B are charts indicating results from characteristic impedance tests conducted on the signal transmission cable according to the first embodiment of the present invention as shown in FIG. 3 using a TDR;

FIGS. 12A and 12B are charts indicating results from characteristic impedance tests conducted on the signal transmission cable according to the fourth embodiment of the present invention as shown in FIG. 7A using a TDR;

FIGS. 13A and 13B are charts indicating results from characteristic impedance tests conducted on the signal transmission cable according to the fifth embodiment of the present invention as shown in FIG. 8A using a TDR; and

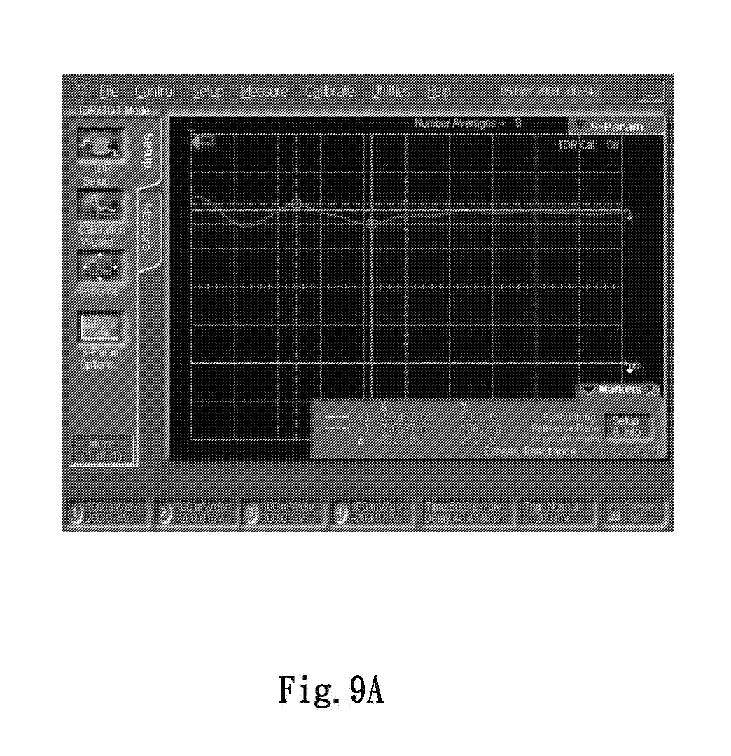

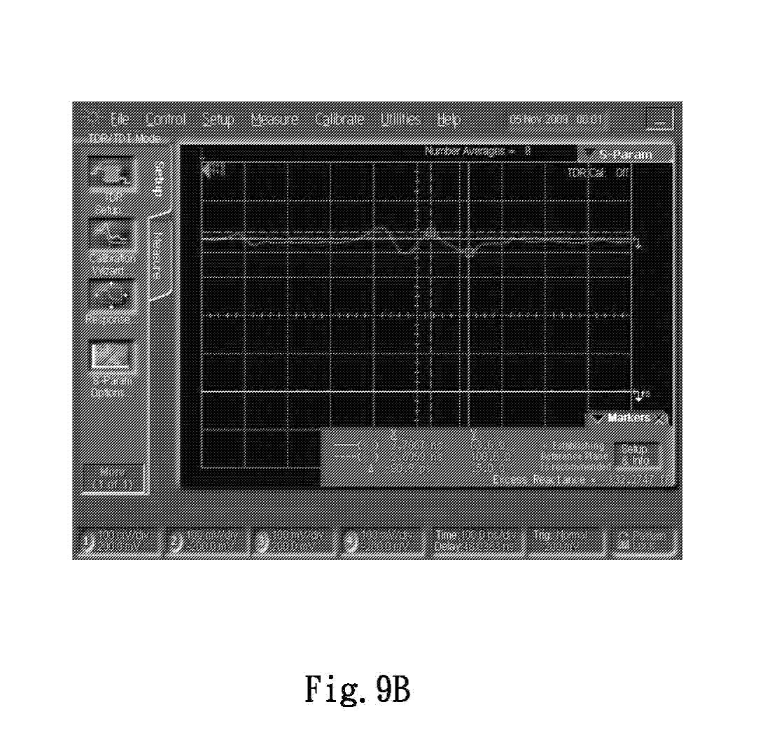

Table 1 is a summary of the characteristic impedance test results in the charts shown in FIGS. 9A, 9B, 10A, 10B, 11A, 11B, 12A, 12B, 13A and 13B to show the influence of differently sized bare sections on the characteristic impedance of a flat signal transmission cable with insulation piercing terminals.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

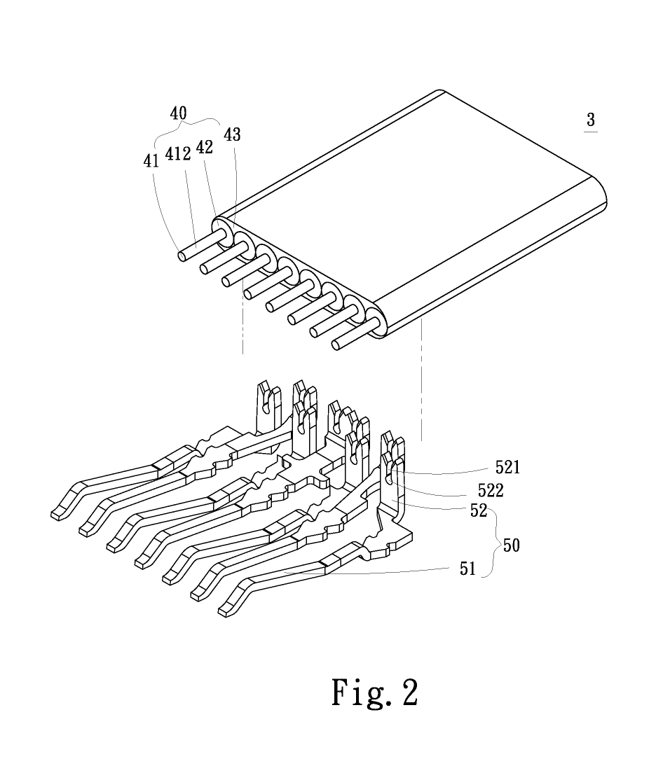

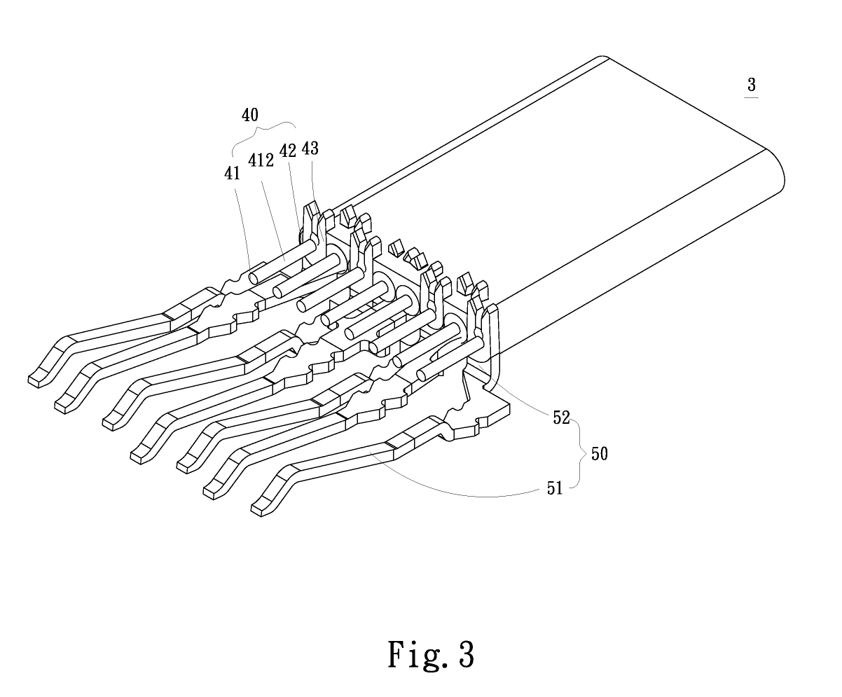

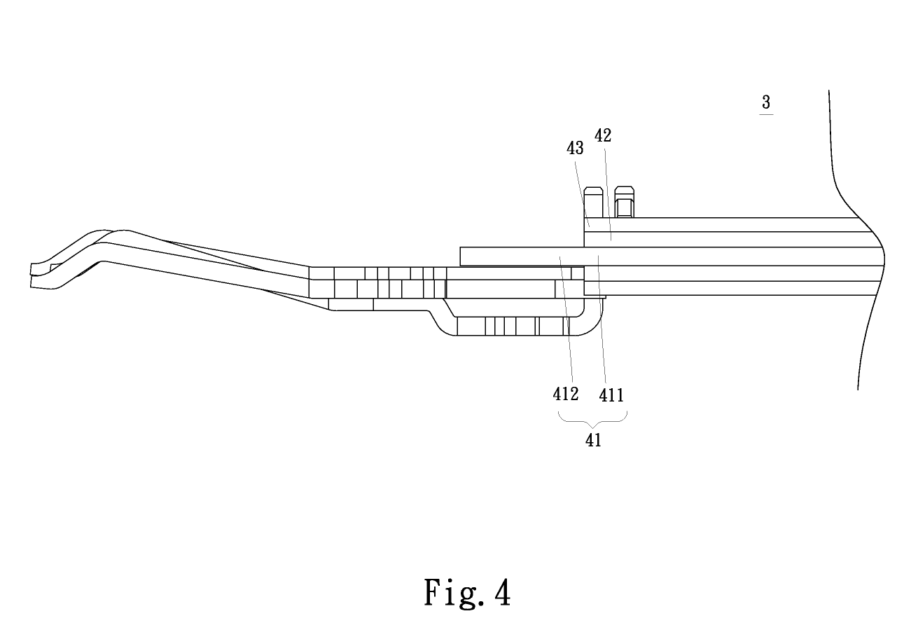

Please refer to FIGS. 2 and 3 that are exploded and assembled perspective views, respectively, of a signal transmission cable with insulation piercing terminals according to a first preferred embodiment of the present invention, and to FIG. 4 that is a sectional side view of FIG. 3. For the purpose of conciseness, the present invention is also briefly referred to as a signal transmission cable herein and is generally denoted by reference numeral 3. As shown, in the first embodiment, the signal transmission cable 3 includes a flat cable 40 and a plurality of conductive terminals 50. The flat cable 40 includes a plurality of conductors 41, each of which has a sheathed section 411 and a bare section 412 located at an end of the sheathed section 411. The sheathed sections 411 are respectively surrounded by a first sheath 42, and all the first sheaths 42 are then surrounded by a common second sheath 43. The bare section 412 has a defined length ranged between 0.01 mm and 4 mm.

The first sheaths 42 and the second sheath 43 surrounding the conductors 41 of the flat cable 40 are made of a non-conductive material. With the first and second sheaths 42, 43, the conductors 41 of the flat cable 40 are protected against short circuit between them, and the entire flat cable 40 is protected against corrosion caused by environmental temperature and humidity.

The conductive terminals 50 respectively include a spring contact 51 and a plurality of piercing sections 52 formed at an end of the spring contact 51. The piercing sections 52 are provided in pairs, and any two paired piercing sections 52 together define a passage 521 between them, and a width-expanded locating slot 522 is formed at a bottom of the passage 521. The paired piercing sections 52 are connected to the conductors 41 in one-to-one correspondence, such that the conductors 41 are respectively located in the passages 521 or moved through the passages 521 into the locating slots 522. The piercing sections 52 pierce through the first and second sheaths 42, 43 for the conductive terminals 50 to electrically connect to the conductors 41, so that digital signals can be transmitted from the flat cable 40 to the conductive terminals 50.

In the illustrated first preferred embodiment, the bared sections 412 are so defined in length that, when the conductive terminals 50 are connected to flat cable 40, some of the paired piercing sections 52 are located at interfaces between the defined bare sections 412 and the sheathed sections 411 of the conductors 41 to pierce through end surfaces of the first sheaths 42 and the second sheath 43 to partially locate in the flat cable 40, while other paired piercing sections 52 pierce through the first and the second sheath 42, 43 to fully locate in the flat cable 40.

When the paired piercing sections 52 pierce through the first sheaths 42 and the second sheath 43, a capacitance effect would occur between the flat cable 40 and the conductive terminals 50 to lower the impedance thereat.

A digital signal transmitted over the flat cable 40 is a broadband signal. In the illustrated embodiment, the digital signal has a defined rise time of ≦250 pico sec (i.e. 250×10⁻¹² sec), and corresponds to a bandwidth of ≦0.5/rise time.

Further, in the process of digital signal transmission, while a low-frequency signal will directly flow to the spring contacts 51 of the conductive terminals 50 without being affected by the stub effect of the bare sections 412, a high-frequency signal will, however, be affected by the stub effect and the parasitic capacitance of the bare sections 412 to flow toward the bare sections 412. By defining the length of the bare sections 412, it is able to reduce the stub effect of the bare sections 412 and accordingly, reduce the parasitic capacitance effect thereof to achieve better impedance matching, so that signal integrity can be maintained and crosstalk interference can be effectively lowered during digital signal transmission, allowing the digital signal to be effectively transmitted to the spring contacts 51.

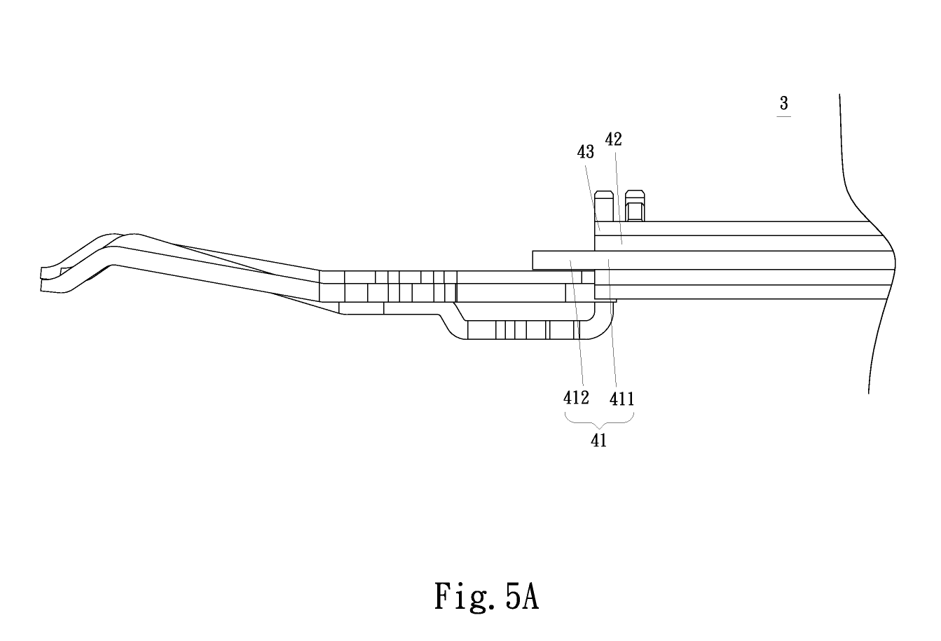

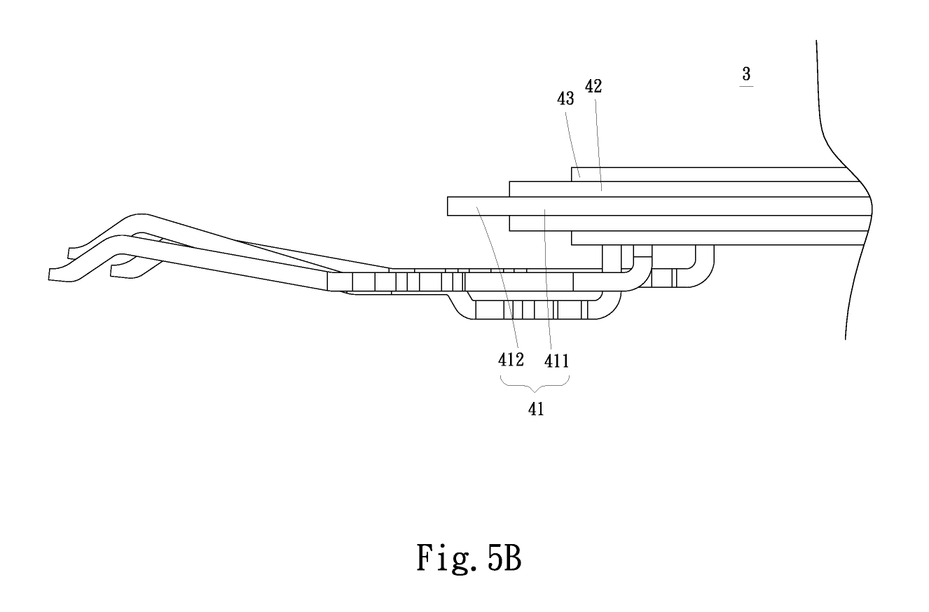

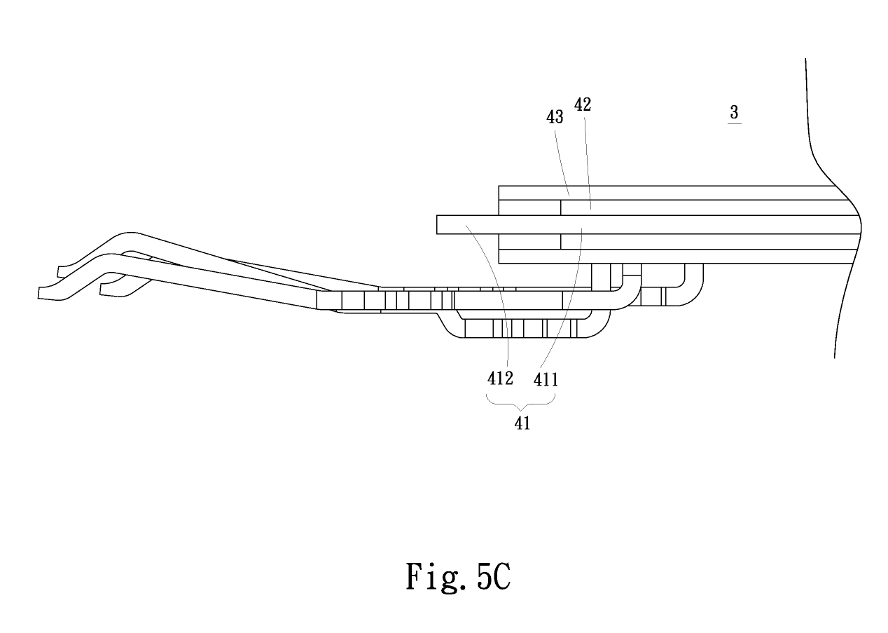

Please refer to FIG. 5A that is a sectional side view of a signal transmission cable 3 according to a second preferred embodiment of the present invention. As shown, the signal transmission cable 3 in the second embodiment is generally structurally similar to the first embodiment, except that, in the second embodiment, the bare sections 412 have a defined length different from that in the first embodiment. As having been mentioned above, the bare sections 412 respectively have a defined length ranged between 0.01 mm and 4 mm, depending on the bandwidth of the digital signal to be transmitted via the flat cable. Therefore, in a first example of the second embodiment as shown in FIG. 5A, the bare sections 412 respectively start at end surfaces of the first sheaths 42 and the second sheath 43, and have a length being so defined that all the paired piercing sections 52 would pierce through the first sheaths 42 and the second sheath 43 to fully locate in the flat cable 40 when the conductive terminals 50 are connected to the flat cable 40. In this manner, it is also possible to reduce the stub effect and accordingly, the parasitic capacitance effect of the bare sections 412, so that signal integrity can be maintained and crosstalk interference can be effectively lowered during digital signal transmission, allowing the digital signal to be effectively transmitted to the spring contacts 51.

FIGS. 5B and 5C are sectional side views of another two examples of the signal transmission cable 3 according to the second preferred embodiment of the present invention. As shown, in the second embodiment, the first sheaths 42 and the second sheath 43 can also be different in length. For example, in FIG. 5B, the first sheaths 42 are longer than the second sheath 43; and in FIG. 5C, the first sheaths 42 are shorter than the second sheath 43. As having been mentioned above, the bare sections 412 respectively have a defined length ranged between 0.01 mm and 4 mm. Therefore, in the second embodiment, the lengths of the first sheaths 42 and the second sheath 43 can be independently adjusted depending on the bandwidth of the digital signal to be transmitted via the flat cable 40, such that the bare sections 412 respectively have a length ranged between 0.01 mm and 4 mm. In this manner, it is also possible to reduce the stub effect and accordingly, the parasitic capacitance effect of the bare sections 412, so that signal integrity can be maintained and crosstalk interference can be effectively lowered during digital signal transmission, allowing the digital signal to be effectively transmitted to the spring contacts 51.

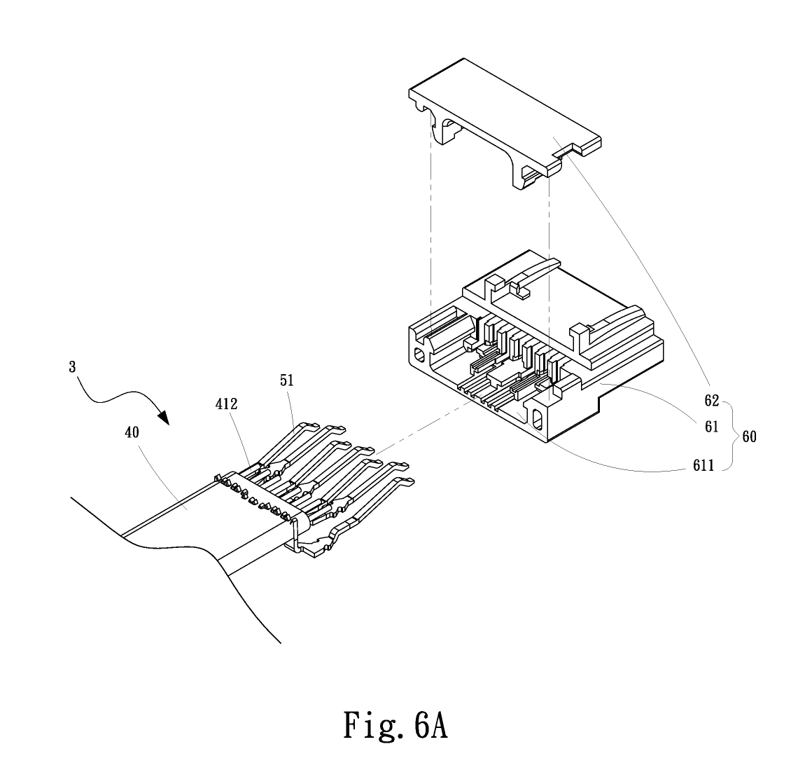

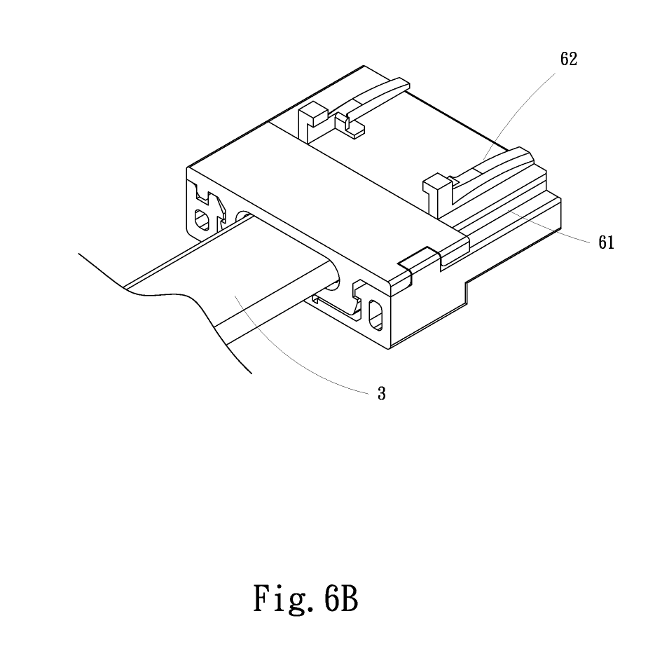

FIGS. 6A and 6B are exploded and assembled views, respectively, of a signal transmission cable 3 according to a third preferred embodiment of the present invention. In the third embodiment, the signal transmission cable 3 is connected to a connector 60. The connector 60 includes a seat 61 and a cover 62 correspondingly closed onto the seat 61. The seat 61 internally defines a receiving space 611 for accommodating an end of the signal transmission cable 3 having the conductive terminals 50 connected thereto. After the cover 62 is correspondingly closed onto the signal transmission cable 3 and the seat 61, the signal transmission cable 3 is securely held in the receiving space 611 with the bare sections 412 also being covered by the cover 62. In this manner, the signal transmission cable 3 and the connector 60 can be quickly and securely assembled to each other.

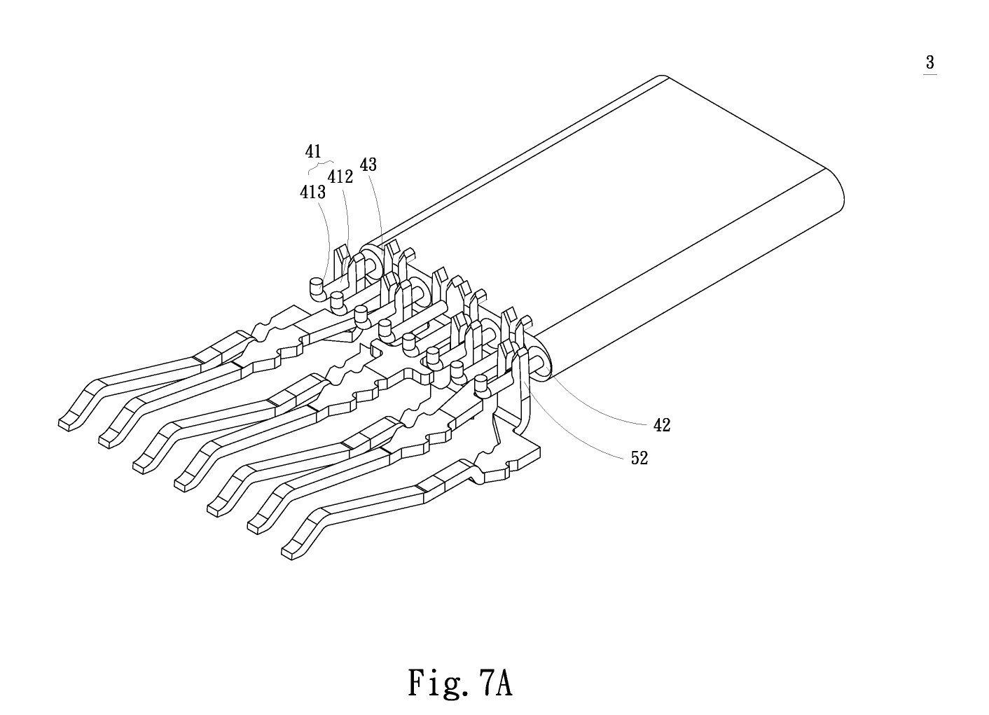

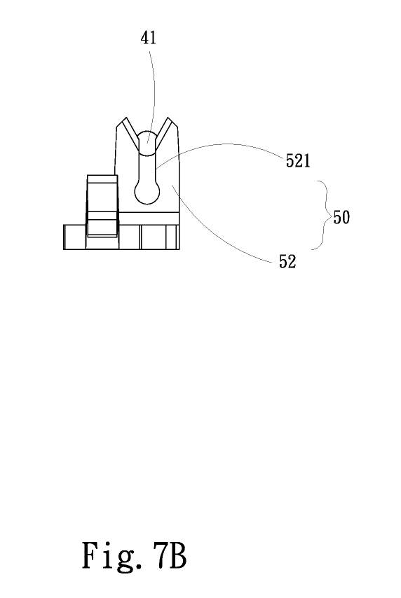

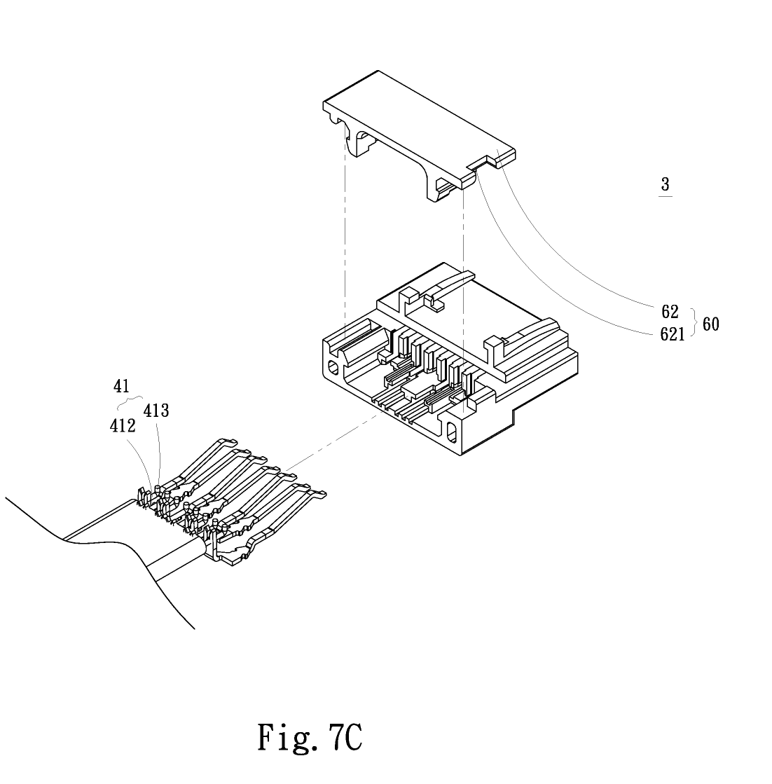

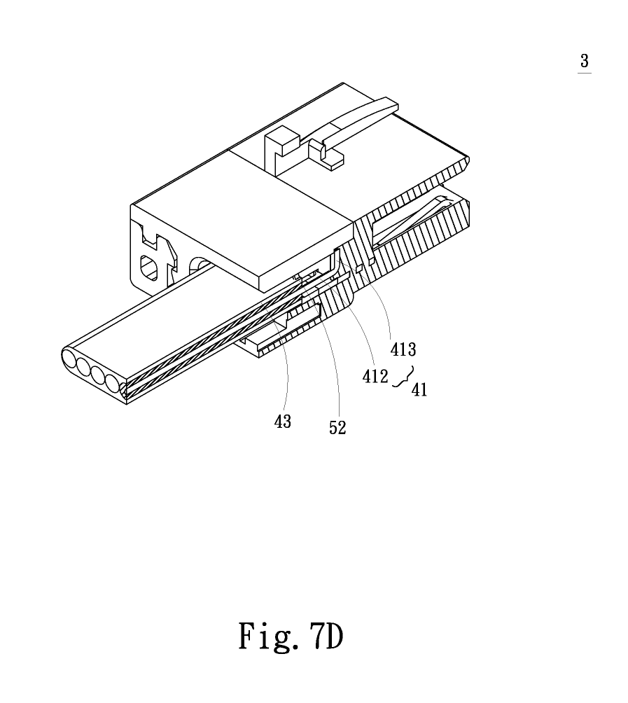

FIGS. 7A and 7B are assembled perspective view and fragmentary cross sectional view, respectively, of a signal transmission cable 3 according to a fourth preferred embodiment of the present invention; and FIGS. 7C and 7D are exploded perspective view and cutaway view, respectively, showing the assembling of the signal transmission cable 3 of the fourth embodiment to a connector 60. As shown, the signal transmission cable 3 in the fourth embodiment is generally structurally similar to the third embodiment, except that, in the fourth embodiment, the bare sections 412 are so defined in length that some of the paired piercing sections 52 are completely located outside the first sheaths 42 and the second sheath 43 to directly contact with the bare sections 412 of the conductors 41 while other paired piercing sections 52 pierce through the first and second sheaths 42, 43 to partially locate in the flat cable 40. It is noted the paired piercing sections 52 in direct contact with the bare sections 412 of the conductors 41 apply a compressing force on the conductors 41 to thereby move the latter into the passages 521. With the conductors 41 being firmly pressed in the passages 521, increased pull strength between the flat cable 40 and the conductive terminals 50 can be obtained.

The bare sections 412 in the fourth embodiment of the present invention respectively have a free end being bent toward the cover 62 to form a bent section 413. Meanwhile, the cover 62 is provided on an inner side at a predetermined position corresponding to the bent sections 413 with a locating section 621. When the signal transmission cable 3 is assembled to the connector 60, the bent sections 413 of the bare sections 412 are hooked to the locating section 621 to enable further increased pull strength between the signal transmission cable 3 and the connector 60. In this manner, the signal transmission cable 3 can be secured to the connector 60, and signal integrity can be maintained and crosstalk interference can be effectively reduced during digital signal transmission.

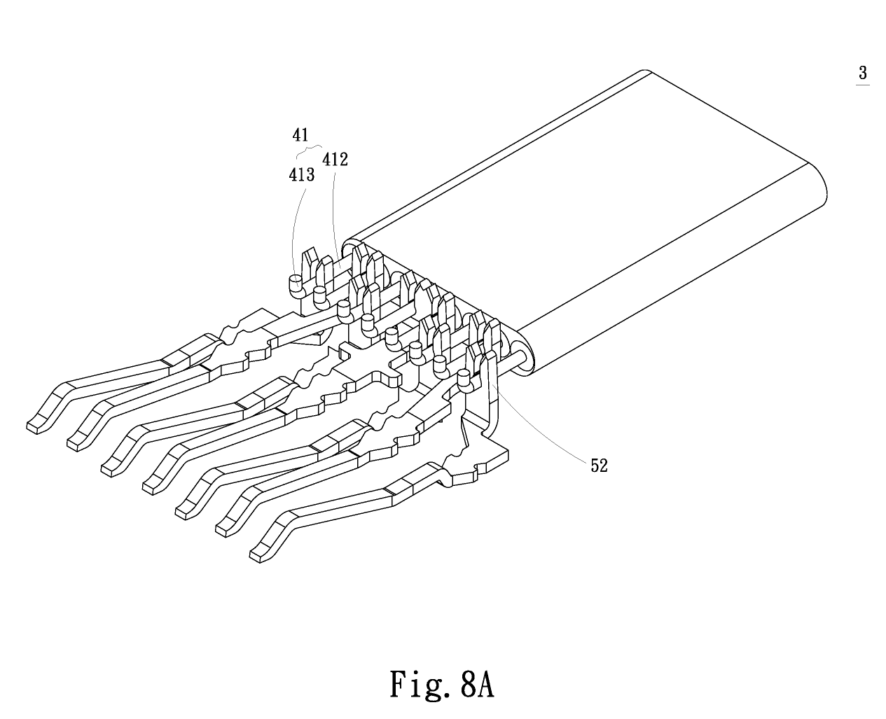

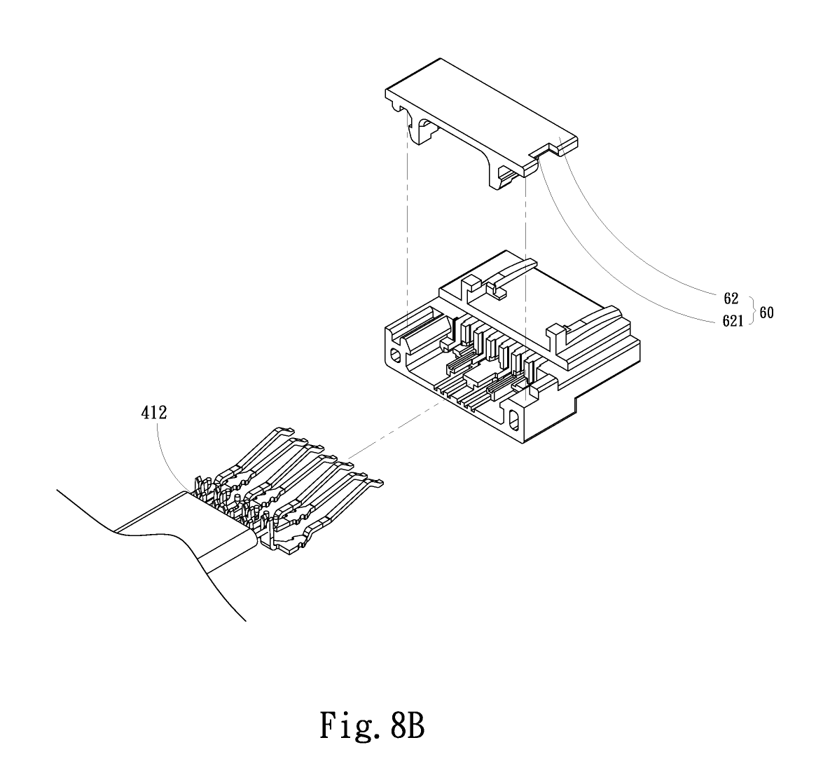

Please refer to FIG. 8A that is an assembled perspective view of a signal transmission cable 3 according to a fifth preferred embodiment of the present invention, and to FIG. 8B that is an exploded perspective view showing the assembling of the signal transmission cable of FIG. 8A to a connector 60. As shown, the fifth embodiment is generally structurally similar to the fourth embodiment, except that the bare sections 412 are so defined in length that all the paired piercing sections 52 are in direct contact with the bare sections 412 of the conductors 41 after the conductive terminals 50 are connected to the flat cable. When the signal transmission cable 3 in the fifth embodiment is connected to a connector 60, the bent sections 413 formed at the free ends of the bare sections 412 are hooked to the locating section 621 formed on the cover 62 of the connector 60 to enable further increased pull strength between the signal transmission cable 3 and the connector 60. In this manner, the signal transmission cable 3 can be secured to the connector 60, and signal integrity can be maintained and crosstalk interference can be effectively reduced during digital signal transmission.

The signal transmission cable according to different embodiments of the present invention are subjected to characteristic impedance test using a time domain reflectometer (TDR) under predetermined conditions, so as to find the influence of the bare sections of different lengths on the characteristic impedance of the signal transmission cable. Data obtained in the tests are displayed on the TDR.

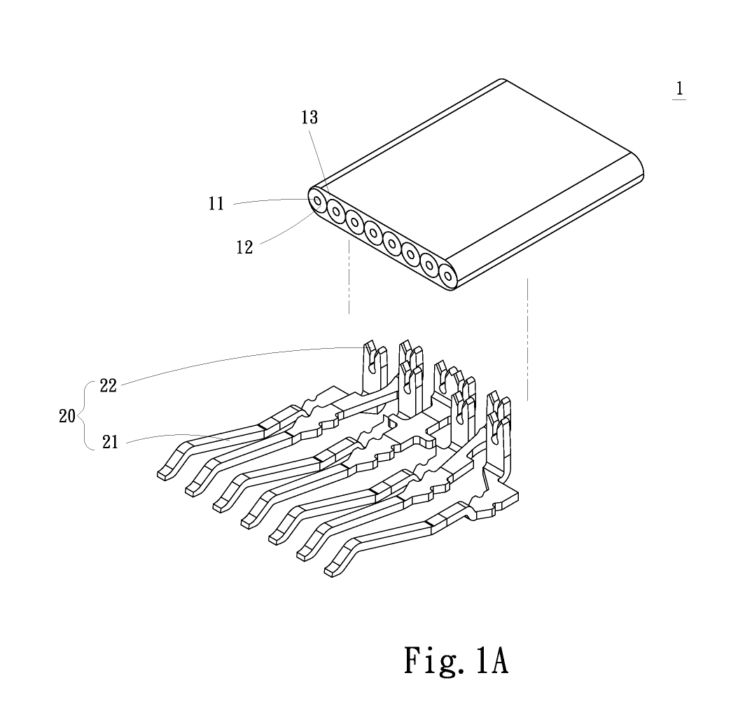

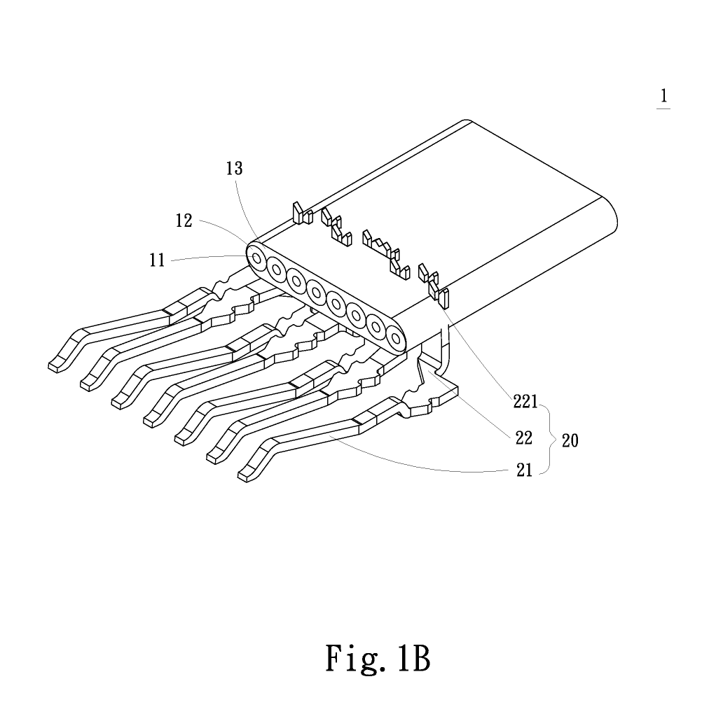

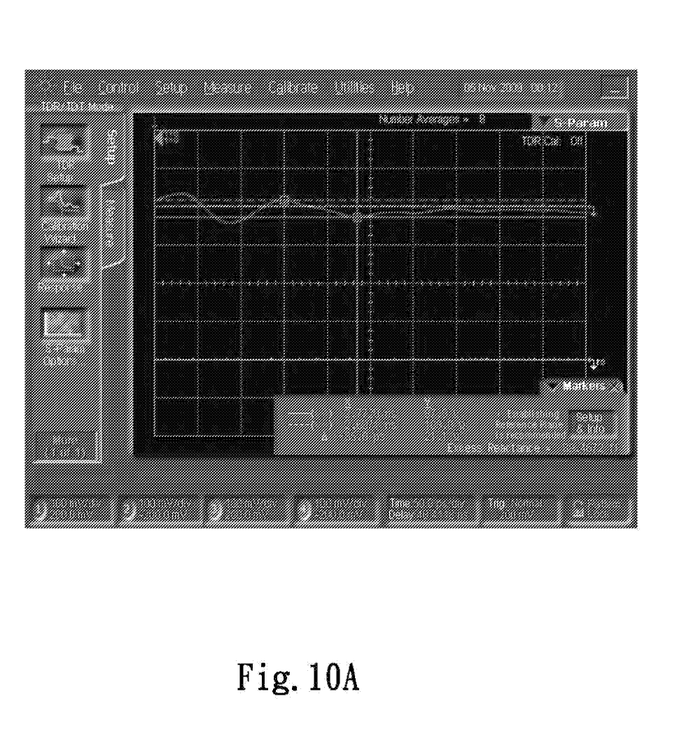

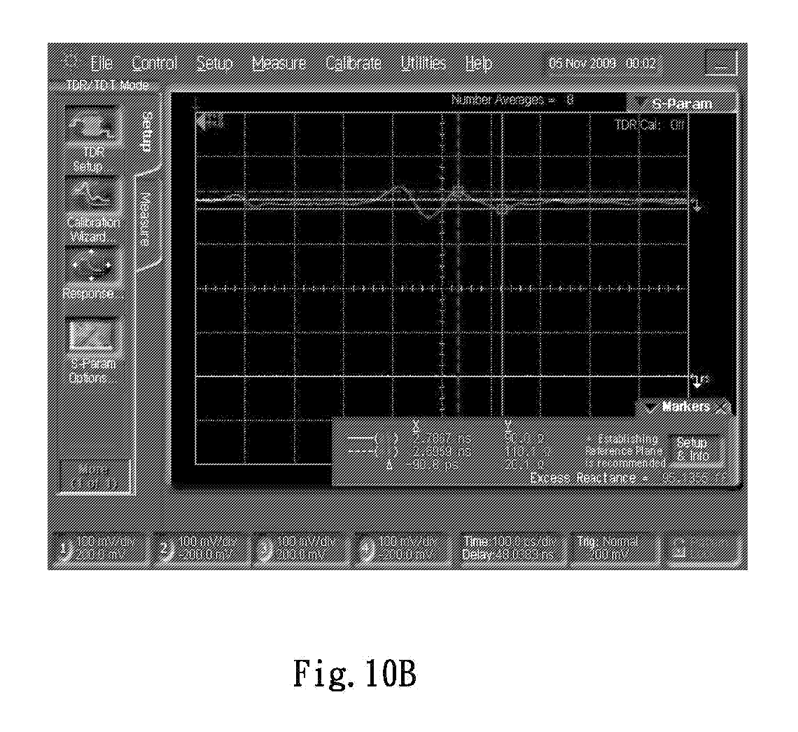

FIGS. 9A and 9B are charts indicating results from characteristic impedance tests conducted on a first conventional flat cable 1 with insulation piercing terminals as shown in FIG. 1B using the TDR. It is noted the conductors 11 of the first conventional flat cable 1 shown in FIG. 1B are completely covered with the inner insulating layer 12 and the outer insulating layer 13 without any bare sections, and all piercing sections 22 pierce through the inner and outer insulating layers 12, 13 to locate in the flat cable 1 when the conductive terminals 20 have been assembled to the flat cable 1; and a top cover (not shown) can be assembled to the flat cable 1. FIGS. 10A and 10B are charts indicating results from characteristic impedance tests conducted on a second conventional flat cable with insulation piercing terminals (not shown) using the TDR. The second conventional flat cable is structurally similar to the first conventional flat cable 1, except that some of the piercing sections 22 are located outside the inner and outer insulating layers 12, 13 of the conductors 11 when the conductive terminals 20 have been assembled to the flat cable.

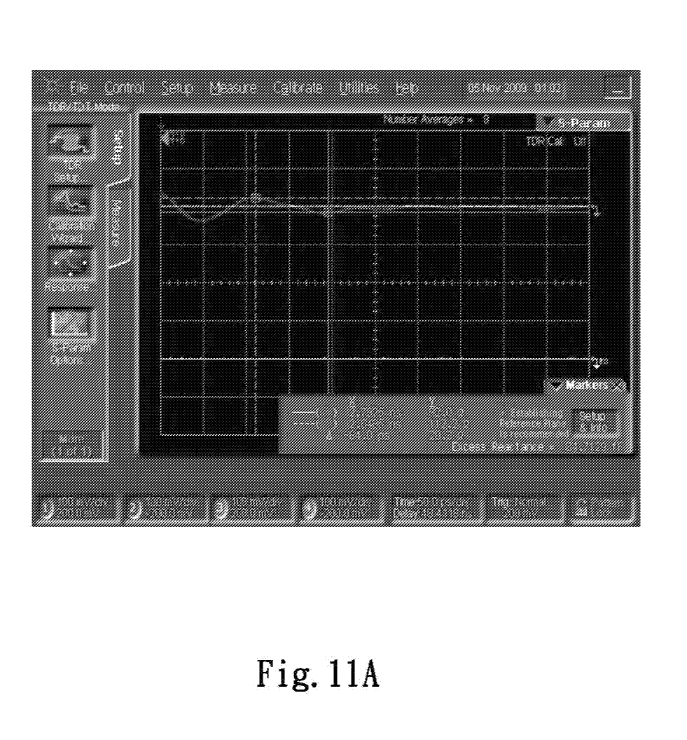

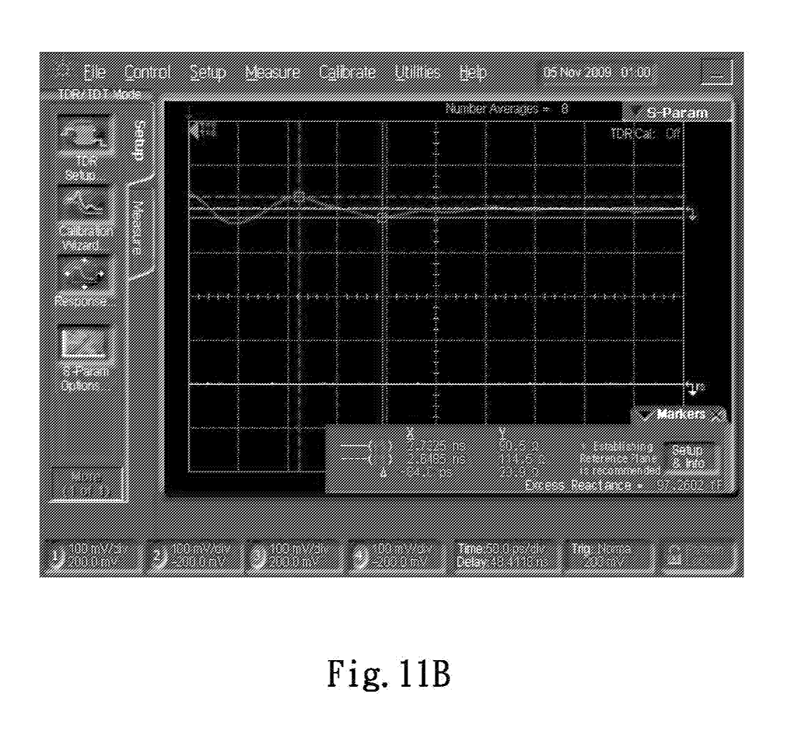

FIGS. 11A and 11B are charts indicating results from characteristic impedance tests conducted on the signal transmission cable 3 according to the first embodiment of the present invention as shown in FIG. 3 using the TDR. It is noted the signal transmission cable 3 in the first embodiment of the present invention includes bare sections 412 in such a length that, when the conductive terminals 50 have been assembled to the flat cable 40, some of the paired piercing sections 52 are located at interfaces between the bare sections 412 and the sheathed sections 411 to pierce through and partially expose from ends surfaces of the first and second sheaths 42, 43 to directly contact with the bare sections 412 while other paired piercing sections 52 pierce through the first and second sheaths 42, 43 to fully locate in the flat cable 40.

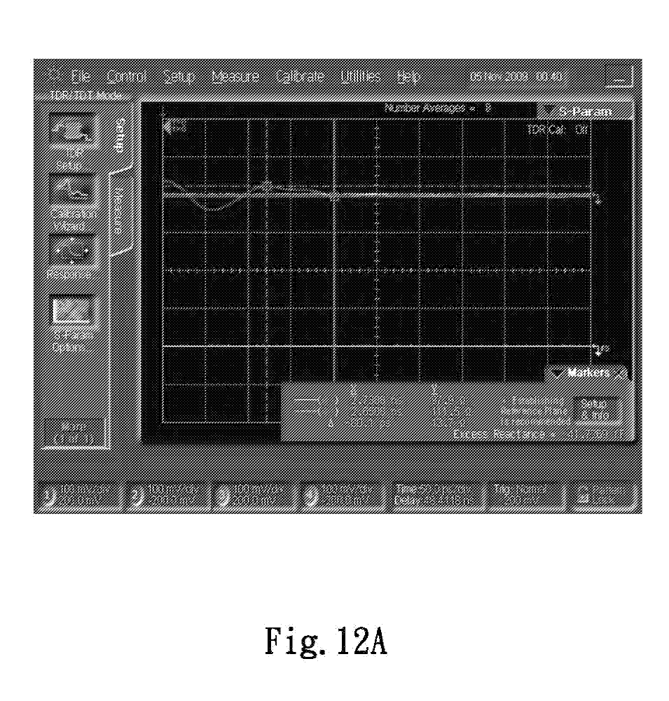

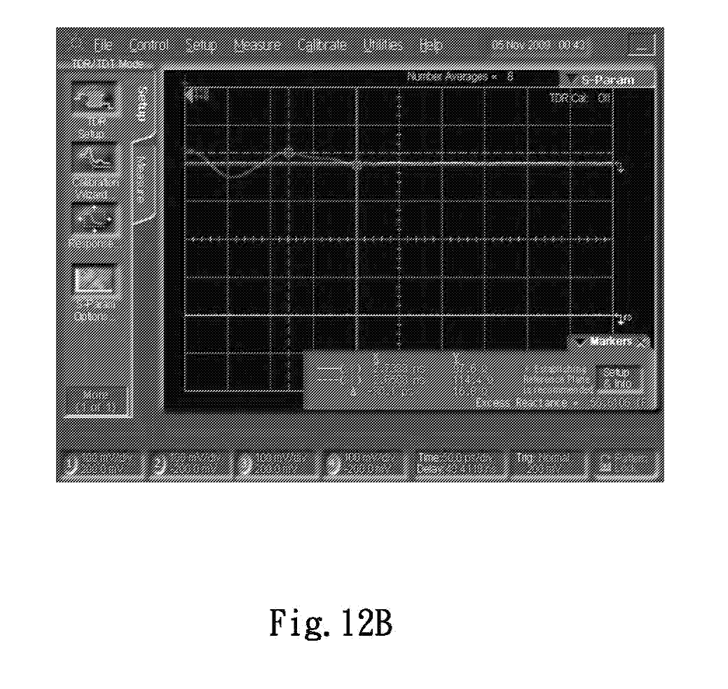

FIGS. 12A and 12B are charts indicating results from characteristic impedance tests conducted on the signal transmission cable 3 according to the fourth embodiment of the present invention as shown in FIG. 7A using the TDR. It is noted the signal transmission cable 3 in the fourth embodiment of the present invention is structurally similar to the first embodiment, except that the bare sections 412 are so defined in length that the paired piercing sections 52 in direct contact with the bare sections 412 of the conductors 41 are completely located outside the first and second sheaths 42, 43 while other paired piercing sections 52 pierce through the end surfaces of the first and second sheaths 42, 43 to partially locate in the flat cable 40.

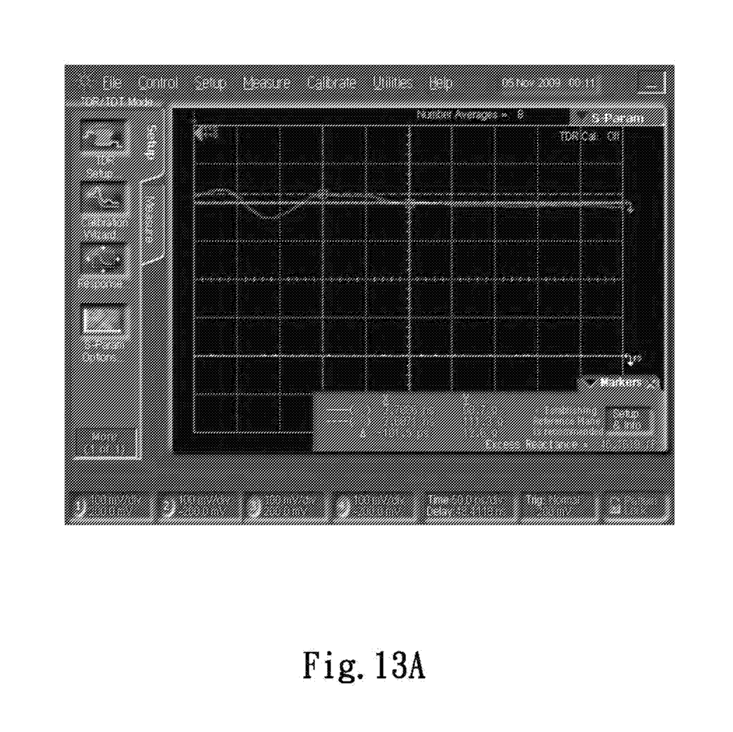

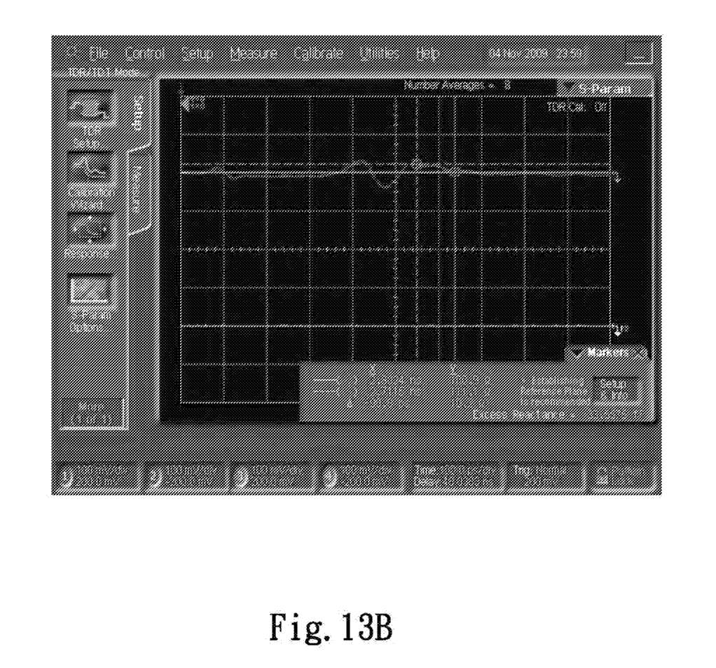

FIGS. 13A and 13B are charts indicating results from characteristic impedance tests conducted on the signal transmission cable 3 according to the fifth embodiment of the present invention as shown in FIG. 8A using the TDR. It is noted the signal transmission cable 3 in the fifth embodiment of the present invention is structurally similar to the fourth embodiment, except that the bared sections 412 are so defined in length that all the paired piercing sections 52 are completely located outside the first and second sheaths 42, 43 to directly contact with the bare sections 412 of the conductors 41.

The obtained data are summarized in Table 1 below.

Table 1 is a summary of the characteristic impedance test results in the charts shown in FIGS. 9A, 9B, 10A, 10B, 11A, 11B, 12A, 12B, 13A and 13B to show the influence of differently sized bare sections on the characteristic impedance of a flat signal transmission cable. The columns named as “mating impedance” show the impedances at contact points between male terminals and female terminals of the connector; the columns named as “IDC” show the impedances at the insulation piercing terminals; and the column named as “NEXT” shows the volume of near-end crosstalk.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A signal transmission cable with insulation piercing terminals, comprising:
a flat cable including a plurality of conductors; each of the conductors including a sheathed section and a bare section located at an end of the sheathed section; the sheathed sections being respectively surrounded by a first sheath before being together surrounded by a second sheath; and the bare sections respectively having a defined length ranged between 0.01 mm and 4 mm; and
a plurality of conductive terminals being connected to the flat cable at the end with the bare sections; the conductive terminals respectively including a spring contact and a plurality of piercing sections formed at an end of the spring contact for connecting to the conductors of the flat cable.

2. The signal transmission cable as claimed in claim 1, wherein the piercing sections on each of the conductive terminals are provided in pairs, and any two paired piercing sections together define a passage between them.

3. The signal transmission cable as claimed in claim 2, wherein each of the passages defined between two paired piercing sections has a bottom formed into a width-expanded locating slot.

4. The signal transmission cable as claimed in claim 1, wherein the flat cable transmits a digital signal that has a frequency within an effective bandwidth corresponding to a rise time of the digital signal, and the rise time of the digital signal being defined as ≦250 pico sec (i.e. 250×10⁻¹² sec).

5. The signal transmission cable as claimed in claim 1, further comprising a connector connected to the end of the flat cable having the conductive terminals connected thereto.

6. The signal transmission cable as claimed in claim 5, wherein the connector includes a seat and a cover correspondingly closed onto the seat.

7. The signal transmission cable as claimed in claim 6, wherein the seat internally defines a receiving space.

8. The signal transmission cable as claimed in claim 6, wherein the cover is provided on one side facing toward the seat with a locating section.

9. The signal transmission cable as claimed in claim 8, wherein the bare sections of the conductors respectively have a free end formed into a bent section, and the bent sections extending toward the cover to engage with the locating section.

10. The signal transmission cable as claimed in claim 1, wherein the piercing sections respectively pierce through the first sheaths and the second sheath to electrically connect to the conductors.
